(19) United States
(12) Patent Application Publication
(10) Pub. No.: US 2024/0202327 A1
(43) Pub. Date: Jun. 20, 2024

(54) APPARATUS FOR CONTROLLING VEHICLE AND METHOD FOR THE SAME

(71) Applicants: Hyundai Motor Company, Seoul (KR); Kia Corporation, Seoul (KR)

(72) Inventor: Dae Hyun Kim, Seoul (KR)

(21) Appl. No.: 18/202,431

(22) Filed: May 26, 2023

(30) Foreign Application Priority Data
Dec. 14, 2022 (KR) 10-2022-0175188

(51) Int. Cl. G06F 21/55; B60W 30/09; B60W 30/12; B60W 30/14; B60W 50/00; B60W 50/14

(52) U.S. Cl. CPC G06F 21/554; B60W 30/09; B60W 30/12; B60W 30/14; B60W 50/0098; B60W 50/14; B60W 2556/45; B60W 2710/18; B60W 2710/20; B60W 2720/106; G06F 2221/034

(57) ABSTRACT

An apparatus for controlling a vehicle and a method for the same are provided. The apparatus includes a plurality of vehicle controllers configured to control the vehicle, an advanced driver assistance system (ADAS) to perform an ADAS function, a hacking monitoring system to monitor whether a hacking activity is sensed in the vehicle and a vehicle control device to adjust performance of at least one vehicle controller of the vehicle controllers, based on a hacking activity being sensed in the vehicle. The ADAS controls an ADAS operation associated with the vehicle controller adjusted in performance, based on the hacking activity being sensed.

### CROSS-REFERENCE TO RELATED APPLICATION

This application claims the benefit of priority to Korean Patent Application No. 10-2022-0175188, filed in the Korean Intellectual Property Office on Dec. 14, 2022, the entire contents of which are incorporated herein by reference.

### TECHNICAL FIELD

The present disclosure relates to an apparatus for controlling a vehicle and a method for the same, and more particularly, relates to an apparatus for controlling a vehicle and a method for the same, capable of coping with cyber hacking, when the cyber hacking is sensed in a vehicle.

### BACKGROUND

In some implementations, the principle of classifying technical levels of an autonomous driving system may be based on an ability to control steering and acceleration-deceleration, a monitoring ability of a driving environment, a fallback ability under a dynamic driving task (DDT) environment, and an operational design domain (ODD) range.

The autonomous driving technologies may be classified into one of level 0 to level 2 in which a driver controls the vehicle and a system is in charge of some driving functions, or into one of level 3 to level 5 in which the system controls the vehicle while being in charge of the whole driving function.

In more detail, level 0 allows the driver to totally control the vehicle, level 1 allows the vehicle system to assist some driving actions, such as steering, accelerating, or decelerating, by the driver, and level 2 allows the system to perform some driving actions, such as steering, accelerating, or decelerating, under the situation that the driver watches the driving actions. Level 3 allows the system to perform autonomous driving in some sections, and allows the driver to be involved in the autonomous driving, if a sudden event occurs. Level 4 may allow the system to control all safety situations in a state that the driver on board is not involved in the driving. Level 5, which may be the final stage, is a stage in which the vehicle autonomously control all driving situations to a destination without the driver. The autonomous driving is classified as level 3 for partial autonomous driving or level 4 for conditional autonomous driving, depending on whether to the driver is involved.

Although a cybersecurity technology of the autonomous driving vehicle has been defined recently, there is no explicit suggestion on the countermeasures for the ADAS controller in charge of autonomous driving, when hacking occurs in the system.

Accordingly, if a hacking event occurs in the vehicle in level 4 of autonomous driving, definition of the restriction for each function of the ADAS and the method for controlling the function of the ADAS are required.

Descriptions in this background section are provided to enhance understanding of the background of the disclosure, and may include descriptions other than those of the prior art already known to those of ordinary skill in the art to which this technology belongs.

### SUMMARY

The following summary presents a simplified summary of certain features. The summary is not an extensive overview and is not intended to identify key or critical elements.

An aspect of the present disclosure provides an apparatus for controlling a vehicle and a method for the same, capable of controlling operations of relevant controllers, when a controller is hacked in an autonomous driving vehicle.

Another aspect of the present disclosure provides an apparatus for controlling a vehicle and a method for the same, enabling a system to perform a fallback function in level 4 of autonomous driving, when hacking occurs in a vehicle.

Another aspect of the present disclosure provides an apparatus for controlling a vehicle and a method for the same, capable of controlling an ADAS controller, which is in charge of autonomous driving, for each function, when the vehicle is hacked.

The technical problems to be solved by the present disclosure are not limited to the aforementioned problems, and any other technical problems not mentioned herein will be clearly understood from the following description by those skilled in the art to which the present disclosure pertains.

An apparatus may comprise: a plurality of vehicle controllers configured to control a vehicle; an advanced driver assistance system (ADAS) configured to perform at least one ADAS operation; a hacking monitoring system configured to determine whether a hacking activity associated with the vehicle is detected; and a vehicle control device configured to adjust, based on a detected hacking activity associated with the vehicle, performance of at least one vehicle controller of the plurality of vehicle controllers, wherein the ADAS is configured to control, based on the detected hacking activity associated with the vehicle, an ADAS operation associated with the at least one vehicle controller.

The ADAS may comprise: a sensor fusion configured to receive an external sensing signal; a plurality of function applications to perform the at least one ADAS operation; and an ADAS control device to control the at least one ADAS operation.

The plurality of function applications may comprise at least one of: Forward Collision-Avoidance Assist (FCA) to assist forward collision-avoidance, Lane Keeping Assist (LKA) to assist lane keeping, Blind-Spot Collision-Avoidance Assist (BCA) to assist rearward collision-avoidance, Intelligent Speed Limit Assist (ISLA) to assist intelligent speed limit, Smart Cruise Control (SCC) to perform smart cruise control, Navigation-based Smart Cruise Control (NSCC) to perform navigation-based smart cruise control, Lane Following Assist (LFA) to assist lane following, or Highway Driving Assist (HDA) to assist highway driving.

The at least one vehicle controller may comprise a power train controller to control longitudinally accelerating, and the ADAS control device may be configured to stop, based on a detected hacking activity associated with the power train controller, at least one function of: the SCC, the NSCC, or the HDA.

The at least one vehicle controller may comprise: a brake controller to control longitudinally decelerating, and the ADAS control device may be configured to stop, based on a detected hacking activity associated with the brake controller, at least one function of: Forward Collision-Avoidance Assist (FCA), Blind-Spot Collision-Avoidance Assist (BCA), Intelligent Speed Limit Assist (ISLA), Smart Cruise Control (SCC), Navigation-based Smart Cruise Control (NSCC), or Highway Driving Assist (HDA).

The at least one vehicle controller may comprise: a steering controller to control lateral driving, and the ADAS control device may be configured to stop, based on a detected hacking activity associated with the steering controller, at least one function of: Forward Collision-Avoidance Assist (FCA), Lane Keeping Assist (LKA), Blind-Spot Collision-Avoidance Assist (BCA), Lane Following Assist (LFA), Highway Driving Assist (HDA).

The at least one vehicle controller may comprise: a gateway for vehicle networking, and the ADAS control device may be configured to stop, based on a detected hacking activity associated with the gateway, a plurality of functions of the plurality of function applications.

The at least one vehicle controller may comprise: a vehicle to everything (V2X) controller for communication with an external device, and the ADAS control device may be configured to maintain, based on a detected hacking activity associated with the V2X controller, operating states of functions of the plurality of function applications.

The at least one vehicle controller may comprise: an audio, video, and navigation (AVN) controller to control a user interface, and the ADAS control device may be configured to stop, based on a detected hacking activity associated with the AVN controller, at least one function of Navigation-based Smart Cruise Control (NSCC).

A method may comprise: determining, by a computing device, whether a hacking activity associated with a vehicle occurs; adjusting, based on a detected hacking activity associated with the vehicle, performance of at least one vehicle controller of the vehicle; and controlling at least one advanced driver assistance system (ADAS) operation associated with the at least one vehicle controller of which performance is adjusted.

An ADAS of the vehicle may comprise: a plurality of function applications to perform the at least one ADAS operation. The plurality of function applications may comprise at least one of: Forward Collision-Avoidance Assist (FCA) to assist forward collision-avoidance, Lane Keeping Assist (LKA) to assist lane keeping, Blind-Spot Collision-Avoidance Assist (BCA) to assist rearward collision-avoidance, Intelligent Speed Limit Assist (ISLA) to assist intelligent speed limit, Smart Cruise Control (SCC) to perform smart cruise control, Navigation-based Smart Cruise Control (NSCC) to perform navigation-based smart cruise control, Lane Following Assist (LFA) to assist lane following, or Highway Driving Assist (HDA) to assist highway driving.

The at least one vehicle controller may comprise: a power train controller to control longitudinally accelerating, and the controlling of the at least one ADAS operation may comprise: stopping, based on a detected hacking activity associated with the power train controller, at least one function of: the SCC, the NSCC, or the HDA.

The at least one vehicle controller may comprise: a brake controller to control longitudinally decelerating, and the controlling of the at least one ADAS operation may comprise: stopping, based on a detected hacking activity associated with the brake controller, at least one function of: the FCA, the BCA, the ISLA, the SCC, the NSCC, or the HDA.

The at least one vehicle controller may comprise: a steering controller to control lateral driving, and the controlling of the at least one ADAS operation may comprise: stopping, based on a detected hacking activity associated with the steering controller, at least one function of: the FCA, the LKA, the BCA, the LFA, or the HDA.

The at least one vehicle controller may comprise: a gateway for vehicle networking, and the controlling of the at least one ADAS operation may comprise: stopping, based on a detected hacking activity associated with the gateway, a plurality of functions of the plurality of function applications.

The at least one vehicle controller may comprise: a vehicle to everything (V2X) controller for communication with an external device, and the controlling of the at least one ADAS operation may comprise: maintaining, based on a detected hacking activity associated with the V2X controller, operating states of functions of the plurality of function applications.

The at least one vehicle controller may comprise: an audio, video, and navigation (AVN) controller to control a user interface, and the controlling of the at least one ADAS operation may comprise: stopping, based on a detected hacking activity associated with the AVN controller, at least one function of the NSCC.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a control block diagram illustrating a vehicle control device;

FIG. 2 is a view illustrating a function of an autonomous driving vehicle based on levels;

FIG. 3 is a view illustrating an advanced driver-assistance system (ADAS) for autonomous driving;

FIG. 4 is a view schematically illustrating a vehicle controller and a vehicle control system;

FIG. 5 is a control flowchart illustrating a vehicle control method;

FIG. 6 is a view illustrating countermeasures when hacking occurs in a controller, in level 4 of autonomous driving;

FIG. 7 is a view illustrating a function of a vehicle related to an ADAS function;

FIG. 8 is a view illustrating a function control of a vehicle when hacking is sensed in relation to an ADAS function;

FIG. 9 is a view illustrating the control of the ADAS controller, when the hacking occurs in the brake controller; and

FIG. 10 illustrates a computing system.

### DETAILED DESCRIPTION

Hereinafter, some embodiments of the present disclosure will be described in detail with reference to accompanying drawings. In adding the reference numerals to the components of each drawing, it should be noted that the identical or equivalent component is designated by the identical numeral even when they are displayed on other drawings. In addition, a detailed description of well-known features or functions will be ruled out in order not to unnecessarily obscure the gist of the present disclosure.

In describing the components according to the present disclosure, terms such as first, second, “A”, “B”, “(a)”, “(b)”, and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

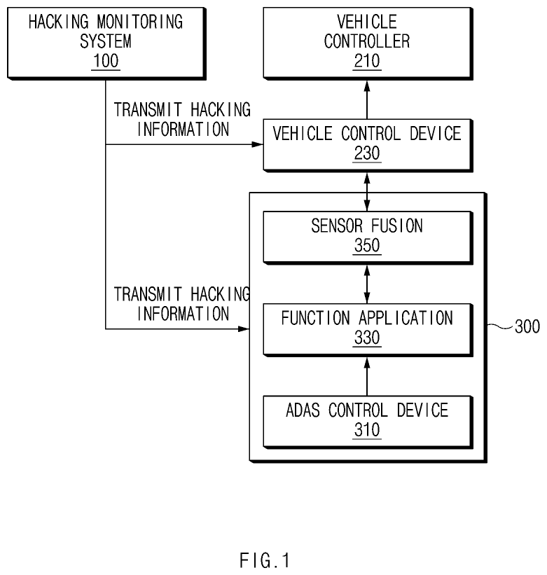

Hereinafter, various features of the present disclosure will be described with reference to FIGS. 1 to 9.

FIG. 1 is a control block diagram illustrating the structure of an apparatus for controlling a vehicle.

Referring to FIG. 1, the apparatus for controlling the vehicle may be implemented in a vehicle. For example, the apparatus for controlling the vehicle may be formed integrally with the internal control units of the vehicle or may be implemented separately from the internal control units of the vehicle to be connected with the internal control units of the vehicle through a separate connector.

As illustrated in accompanying drawings, the apparatus for controlling the vehicle may include a hacking monitoring system 100, a vehicle controller 210 to perform the function of the vehicle, a vehicle control device 230 to control the hacking monitoring system 100 and the vehicle controller 210, an advanced driver assistance system (ADAS) 300 to perform and control an autonomous driving function.

The vehicle control device 230 may include a plurality of components to perform one or more functions of the vehicle although not illustrated. For example, the vehicle control device 230 may include a power train controller to control longitudinally accelerating driving, a brake controller to control longitudinally decelerating driving, a steering controller to control lateral driving, a gateway for vehicle networking, a vehicle to everything (V2X) controller for communication with an external device, and an audio, video, navigation (AVN) controller to control a user interface.

In the present disclosure, although the ADAS 300 is described as a separate component for the convenience of explanation, the ADAS 300 may be implemented in the form of a part of the vehicle control device 230 or the form merged into the vehicle control device 230.

The power train controller may include an electronic control unit, an engine control unit, a motor control unit (MCU), a fuel control unit (FCU), or a transmission control unit (TCU).

The ADAS 300 may include a sensor fusion 350 to receive and transmit an external sensing signal, a plurality of function applications 330 to perform the ADAS function, and an ADAS control device 310 to control the function application 330 to control the ADAS function.

One or more components constituting the apparatus for controlling the vehicle are not essentially referred to as separate devices physically distinguished from each other. In other words, the hacking monitoring system 100, the vehicle controller 210, the vehicle control device 230, and the ADAS 300 of FIG. 1 may be hardware units constituting the apparatus for controlling the vehicle, which are merely functionally divided into each other depending on operations performed by the hardware units, and the hardware units need not to be provided independently from each other. In some implementations, at least one of the hacking monitoring system 100, the vehicle controller 210, the vehicle control device 230, and the ADAS 300 may be implemented in the form of separate devices physically separated from each other.

Before the description according to the present disclosure, the function(s) of the autonomous driving vehicle will be described in more detail.

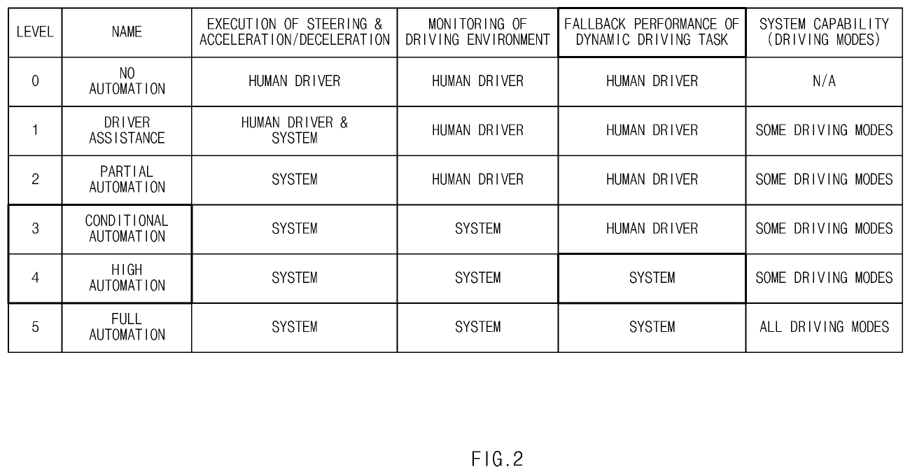

FIG. 2 is a view illustrating one or more functions of the autonomous driving vehicle based on levels.

As described above, the principle of classifying technical levels of an autonomous driving system may be based on an ability to control steering and acceleration-deceleration, a monitoring ability of a driving environment, a fallback ability under a dynamic driving task (DDT) environment, and an operational design domain (ODD) range. Level 1 and level 2 of autonomous driving may be related to the steering system, the brake system, and the acceleration system (e.g., electronic control unit; engine control unit; TCU, etc.) to laterally and/or longitudinally control the vehicle. Level 3 of autonomous driving may be related to the communication system (V2X) for communication with the outside (e.g., an external device) in relation to the driving environment. In level 4 of autonomous driving, the redundancy system for the fallback function may be provided.

As illustrated in FIG. 2, level 3 and level 4 may be determined depending on whether the fallback function for an accident is performed by the system or a driver.

The fallback ability may be classified in level 4 of an autonomous driving system (e.g., when the system is able to cope with all dangerous situations). According to level 4, the system may make all decisions in an ODD region designed by the system, and may be a high-automation drive without requesting the transfer of the right of control to the driver until reaching an ODD boundary. In level 4 of autonomous driving, a driver may not maintain an alert state in an emergency situation. In other words, in level 4, the system may perform autonomous driving by determining a condition of minimizing a risk regardless of the handling of the driver.

The fallback refers to a function (e.g., a deceleration function or a stop function on the shoulder of a road) performed by a system to minimize the risk caused by driving, based on the self-determination of the system, when the operation of the autonomous driving system and a control-related function are not normally performed due to the failure and/or the deviation out of a drivable region, and/or the driving to a set destination is difficult.

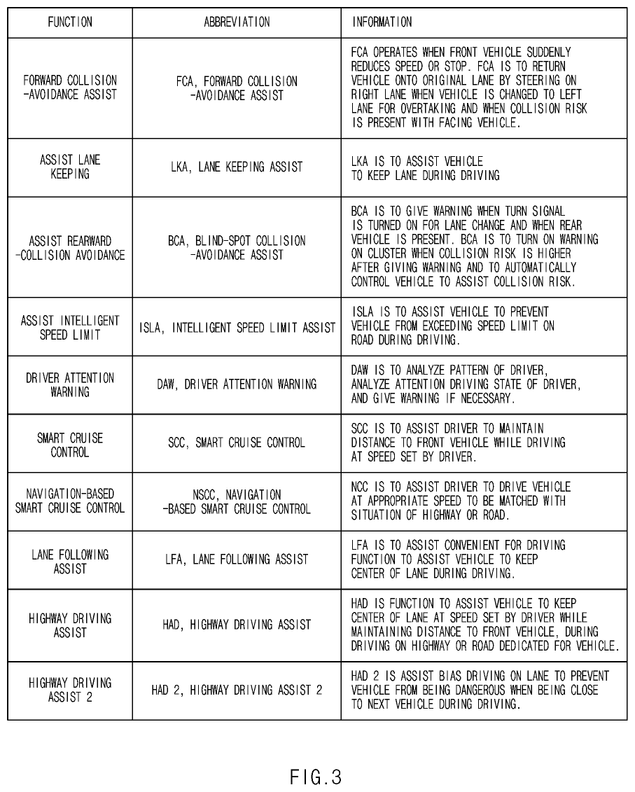

FIG. 3 is a view illustrating an ADAS for autonomous driving.

As illustrated in FIG. 3, the function of autonomous driving may include Forward Collision-Avoidance Assist (FCA), which is to assist forward collision-avoidance, Lane Keeping Assist (LKA), which is to assist lane keeping, Blind-Spot Collision-Avoidance Assist (BCA), which is to assist rearward collision-avoidance, Intelligent Speed Limit Assist (ISLA), which is to assist intelligent speed limit, Smart Cruise Control (SCC), which is to perform smart cruise control, Navigation-based Smart Cruise Control (NSCC), which is to perform navigation-based smart cruise control, Lane Following Assist (LFA), which is to assist lane following, and Highway Driving Assist (HDA) and Highway Driving Assist 2 (HDA 2) which are to assist highway driving. The individual functions may be individually operated by the function application 330 of FIG. 1 and may be controlled by the ADAS control device 310.

Some vehicle electronic systems may be controlled by an electronic control unit to transmit and/or receive data through a controller area network (CAN) bus. The electronic control unit provided in the vehicle may be uniquely specified with a processor identifier (ID) and a communication encryption key. Accordingly, the electronic control unit may determine the processor ID and the communication encryption key through program (e.g., whenever the communication is made), and may issue a command for blocking the communication when a hacking activity (e.g., a hacking attempt, a hacking event, a malfunction caused by a hacking event, etc.) is suspected. However, as hacking is advanced, all software operations of the electronic control unit may be modulated. Accordingly, normal communication data transmitted on the CAN bus may be monitored, the processor ID and the encryption key may be inferred and forged, and/or the command for blocking the communication may be ignored. Accordingly, to fundamentally prevent communication interference and malicious data transmission by hacking, communication of a hacked node may need to be blocked in hardware on the CAN bus.

To block the node that has been already hacked to interfere CNN communication and to transmit malicious data, an individual node may need to be uniquely specified on the CAN bus. However, there may be no function, such as Media Access Control (MAC) address over an Ethernet, for identifying the individual node.

To cope with CAN bus attacks, the Intrusion Detection System (IDS) may analyze the content of the data frame to determine whether a node currently transmitting data is a hacked node. The IDS may always monitor the CAN bus, and a certain node may transmit a malicious data frame. In this case, the IDS may analyze the data content to detect that the node has been hacked.

For one or more hacking activities that CAN IDS cannot detect, controller integrity is currently determined in real time using MAC.

The following description according to the present disclosure will be made regarding a subsequent control manner, in detail, the ADAS function, to be performed, when the hacking state of the controller is sensed in an autonomous driving vehicle (e.g., in level 4 or any other autonomous driving level).

Referring back to FIG. 1, the hacking monitoring system 100 of the apparatus for controlling the vehicle may monitor whether a hacking activity occurs in the vehicle and transmit the hacking information to the vehicle control device 230 and the ADAS 300.

The hacking monitoring system 100 may determine whether an hacking activity occurs by verifying the integrity of the controller in real time. The hacking monitoring system 100 may include a detailed controller for the determination.

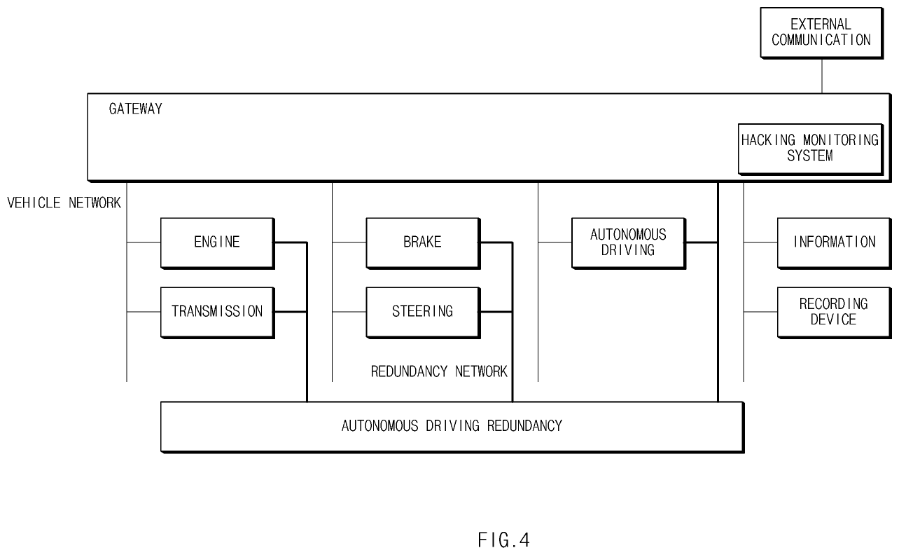

The vehicle controller 210 may be expressed as in table 1 and schematized as in FIG. 4, depending on the functions of a vehicle to be performed by control systems.

TABLE 1

| Characteristic | Controller |
|---|---|
| Longitudinal acceleration | Engine controller (motor, fuel cell), |
| | transmission controller |
| Longitudinal deceleration | Brake controller |
| Lateral direction | Steering controller |
| Automation | Autonomous driving system (ADAS included) |
| Vehicle network | Gateway |
| External communication | Communication device |
| External communication | Communication device C-ITS |
| Information | AVN |
| Recording device | Accident recorder |

As shown in Table 1, an engine controller, a motor controller, a fuel cell controller, and/or a transmission controller, which may be associated with engine control for longitudinally accelerating, may be included in the control system, and a brake controller for longitudinally decelerating, and a steering controller for lateral control may be included in the control system. A gateway for networking of a vehicle, a communication device for external communication, an audio, video, navigation (AVN) or infotainment that provides information and entertainment to a user, and an incident recorder to record events occurring in a vehicle may be included an in-vehicle control system. According to an example, an autonomous driving system including ADAS may be included in the vehicle controller 210 for autonomous driving.

FIG. 4 is a view schematically illustrating a vehicle controller and a vehicle control system.

Each controller may be connected to a gateway for a vehicle network, and each controller may be connected to an autonomous driving redundancy system (e.g., for level 4 of autonomous driving). The hacking monitoring system may be connected to the gateway to verify the real-time integrity of each controller.

If a hacking activity is sensed/detected in the vehicle, the vehicle control device 230 may detect a safety zone in front of the vehicle, set an entry path for entering the safety zone, and adjust the performance of the vehicle controller 210 depending on the entry state to the entry path.

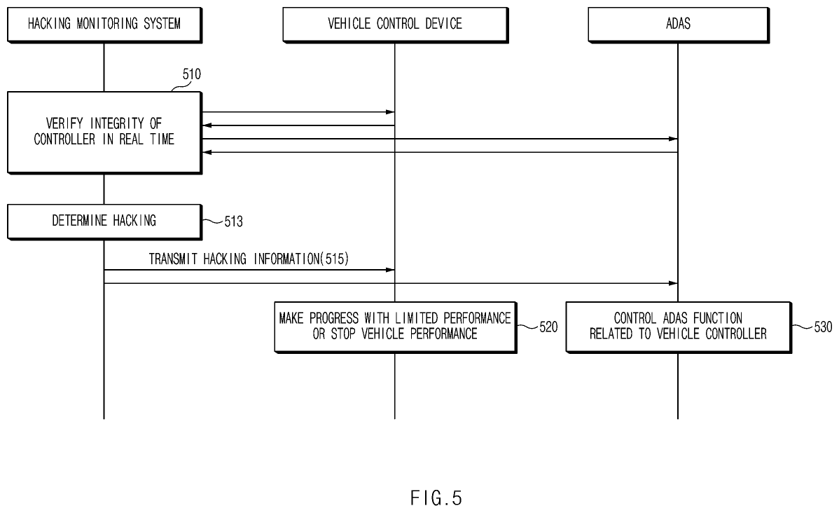

FIG. 5 is a control flowchart illustrating a vehicle control method. The vehicle control method according to the present disclosure will be described in detail with reference to FIG. 5.

Hereinafter, it is assumed that the apparatus for controlling the vehicle of FIG. 1 performs the process of FIG. 5, but aspects of the present disclosure are not limited thereto. Other apparatus may also perform the process of FIG. 5. In the following description made with reference to FIG. 5, it may be understood that the described operation is controlled by each component of the apparatus for controlling the vehicle.

The hacking monitoring system 100 may verify (e.g., in real time) whether a hacking activity occurs in the vehicle (510).

If the hacking activity is sensed, the hacking monitoring system 100 may determine the hacking activity (513), and transmit a signal indicating the determination to the vehicle control device 230 and the ADAS 300 of FIG. 1 (515). If the hacking information is transmitted, the vehicle control device 230 and the ADAS 300 may recognize the hacking activity and perform a control operation corresponding to the hacking activity (520 and 530, respectively).

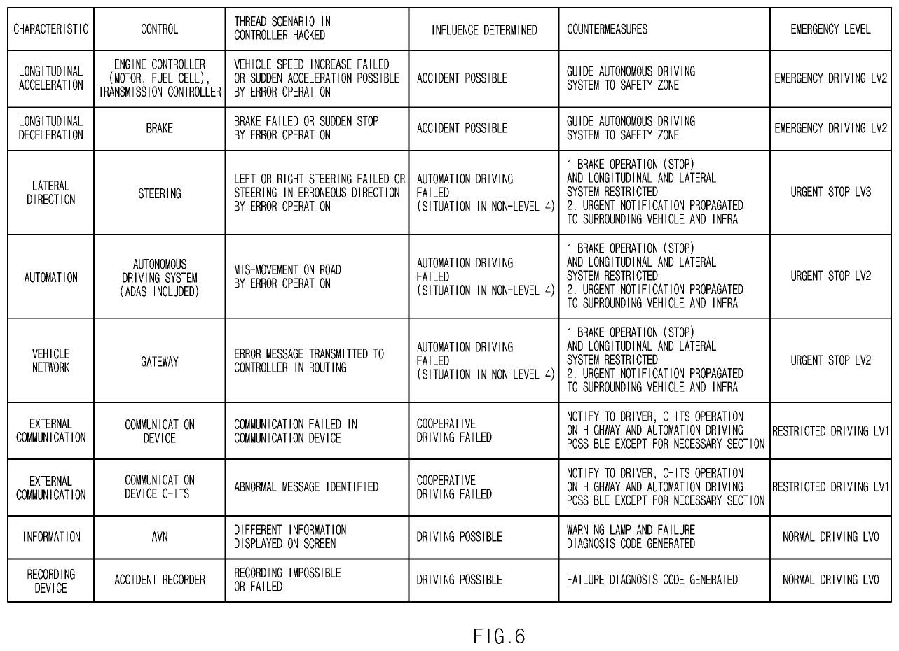

If the vehicle control device 230 recognizes a hacking activity, the vehicle controller 210 may be controlled (e.g., as illustrated in FIG. 6). FIG. 6 is a view for describing a countermeasure in the hacking of a controller in level 4 of autonomous driving.

Table 2 relates to an emergency driving level, and shows control of the vehicle controller 210 depending on a risk level.

TABLE 2

| | Risk | | |
|---|---|---|---|
| Operating item | level | Hacking controller | Countermeasures |
| Normal operation | lv0 | Controllers except | Normally operate |
| | | for following | identically to |
| | | controllers | existing operation |
| Limit operation | lv1 | External | Normally operate |
| in specific region | | communication | in addition to |
| | | controller | region requiring |
| | | | cooperation |
| | | | autonomous driving |
| | | | (ex C-ITS) |
| Risk minimization | lv2 | Engine, | Control autonomous |
| | | transmission, | system stepwise to |
| | | brake | guide to safety |
| | | | region |
| Sudden stop | lv3 | Steering, ADAS, | Function stopped |
| | | gateway | because guide to |
| | | | safety region is |
| | | | difficult due to |
| | | | loss in function |
| | | | of main controller |

As illustrated in Table 2, if a hacking activity occurs in the external communication controller, the vehicle may be driven in a specific-zone restriction driving mode. The vehicle control device 230 may control the vehicle controller 210 such that cooperative autonomous driving (ex C-ITS) normally operates in addition to a necessary region.

When a hacking activity occurs in the engine, transmission, and brake, the vehicle may be in risk level 2 (lv2), and the vehicle may be driven in a risk minimization driving mode. The vehicle control device 230 may stepwise control the autonomous driving system such that the vehicle is guided to the safety zone.

If a vehicle controller, such as steering, ADAS, or gateway, is hacked, the vehicle control device 230 may stop the function of the vehicle because it may be difficult to guide the safety region due to the loss of a main controller function. If the steering controller is hacked, it may be difficult to stepwise guide a safety zone. Accordingly, the vehicle control device 230 may stop the function of the vehicle as if the vehicle stops functioning when the fuel is insufficient.

FIG. 6 is a more specific example of Table 2, which shows changes in the operation and performance of other control systems when a hacking activity occurs in each control system of the vehicle controller 210.

As illustrated in FIG. 6, if at least one of the electronic control unit, the engine control unit, the motor control unit, the fuel control unit, and the transmission control unit related to longitudinally accelerating is hacked, the vehicle speed may not be increased or sudden acceleration may be caused by malfunction. Accordingly, the vehicle control device 230 may control the autonomous driving system such that the vehicle moves into the safety zone. For example, the vehicle control device 230 may stops the function of the vehicle controller hacked and may normally operate the performance of remaining vehicle controllers until the vehicle enters a safety zone of the specific region. After the vehicle enters the safety zone, the vehicle control device 230 may decrease the performance of the remaining vehicle controllers into a preset range.

If the brake controller is hacked in relation to the longitudinally decelerating, the vehicle may be suddenly stopped due to the breakage of the brake or the malfunction of the brake. Accordingly, the vehicle control device 230 may stop the function of the brake controller and may normally operate the performance of the remaining vehicle controllers until the vehicle enters the safety zone of the specific region. After the vehicle enters the safety zone, the vehicle control device 230 may decrease the performance of the remaining vehicle controllers into a preset range.

If the steering controller related to a lateral control of the vehicle is hacked, the vehicle control device 230 may stop the function of the steering controller, may control the electronic control unit, the engine control unit, the motor control unit, the fuel control unit, and the transmission control unit, such that the vehicle is not accelerated, and may control the brake controller and the ADAS control device 310 such that the function is stopped after a specific time is elapsed. The vehicle control device 230 may transmit an emergency alarm to a surrounding vehicle and/or a surrounding infrastructure.

If the ADAS 300 related to the autonomous driving is hacked, the vehicle control device 230 may stop the function of the ADAS control device 310, may control the electronic control unit, the engine control unit, the motor control unit, the fuel control unit, and the transmission control unit, such that the vehicle is not accelerated, and may control the brake controller and the steering controller such that the function is stopped after a specific time is elapsed.

If the gateway for the vehicle networking is hacked, the vehicle control device 230 may stop the function of the gateway, may control the electronic control unit, the engine control unit, the motor control unit, the fuel control unit, and the transmission control unit, such that the vehicle is not accelerated, and may control the brake controller, the steering controller, and the ADAS control device 310 such that the function is stopped after a specific time is elapsed.

Remaining relevant controllers may be controlled to be normally operated in a specific region as illustrated in FIG. 6 or may be maintained to be normally operated. The AVN in charge of delivering information may indicate the fact that a hacking activity occurs and the operating state of the current controllers and may inform that the hacking activity occurs and the operating state of the current controllers to the driver, except for the case that the AVN is hacked.

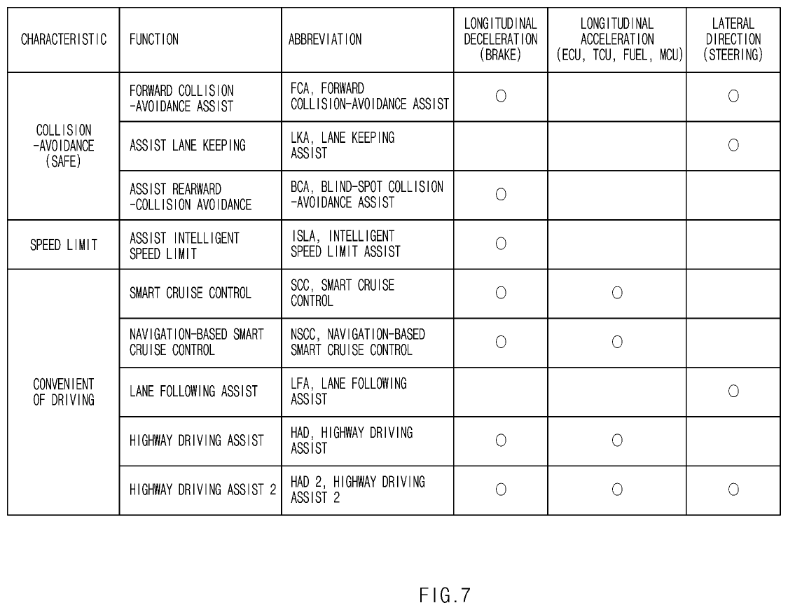

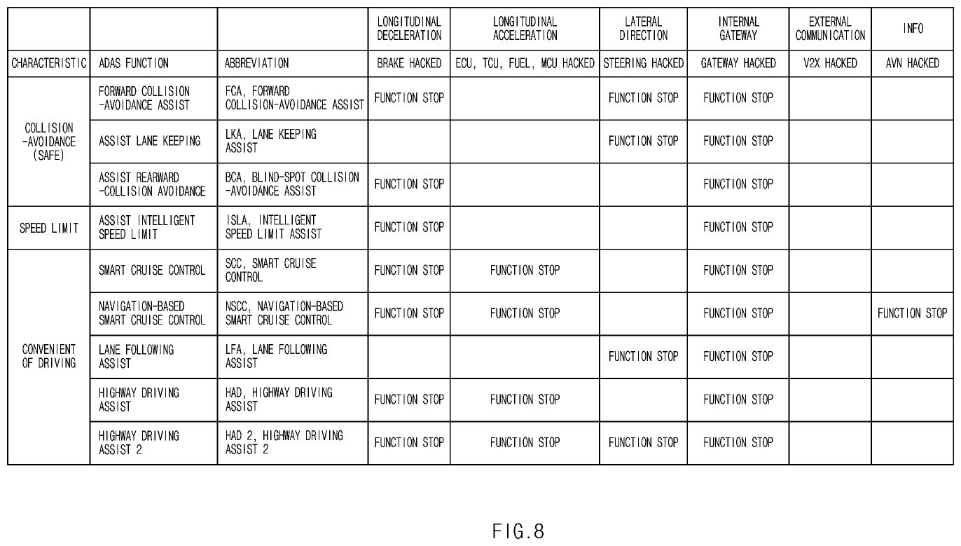

FIG. 7 is a view illustrating a function of a vehicle related to an ADAS function, and FIG. 8 is a view illustrating a function control of the vehicle when hacking is sensed in relation to the ADAS function.

Since the operation of the vehicle controller 210 is related to the ADAS function as illustrated in FIG. 7, when a hacking activity occurs in the vehicle controller 210, the ADAS function may be controlled as illustrated in FIG. 8.

The ADAS function may be performed through the ADAS control device 310 that controls the function application 330, and such a control operation may be performed based on the vehicle control unit 230.

As illustrated in FIG. 8, the vehicle controller may include a power train controller to control the longitudinally accelerating. When the hacking is sensed in the power train controller, the ADAS control device 310 may stop the functions of SCC, NSCC, HDA, and HDA 2.

The vehicle controller may include the brake controller to control the longitudinally decelerating. If a hacking activity is sensed in the brake controller, the ADAS control device 310 may stop the functions of the FCA, BCA, ISLA, SCC, NSCC, HDA, and/or HDA 2

The vehicle controller may include the steering controller to control the lateral driving. If a hacking activity is sensed in the steering controller, the ADAS control device 310 may stop the functions of the FCA, LKA, BCA, LFA, and/or HDA.

The vehicle controller may include an internal gateway for vehicle networking. If the gateway is hacked, the ADAS control device 310 may stop all functions of the plurality of functional applications 330.

The vehicle controller may include a vehicle to everything (V2X) controller for communication with the outside (e.g., an external device). If the V2X controller is hacked, the ADAS control device 310 may maintain intrinsic functions of a plurality of functional applications 330.

The vehicle controller may include an audio, video, and navigation (AVN) controller that controls the user interface. If the AVN controller is hacked, the ADAS control device 310 may stop the NSCC function.

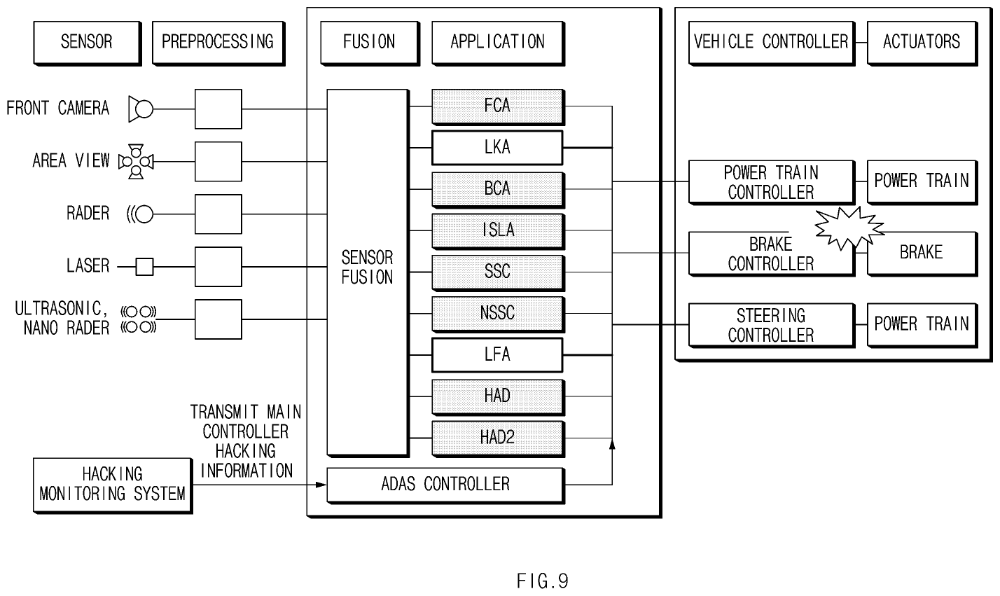

FIG. 9 is a view illustrating the control of the ADAS controller, when the hacking occurs in the brake controller.

FIG. 9 illustrates an example in which hacking occurs in a brake controller in FIG. 8.

As described above, sensing data for executing the ADAS function may be input into the sensor fusion, and the ADAS function may be executed based on the sensing data.

If a hacking activity is sensed in the brake controller, the hacking information may be transmitted to the ADAS control device 310 by the hacking monitoring system, and the ADAS control device 310 may stop the ADAS function related to the brake controller.

As illustrated in FIG. 9, if the hacking activity is sensed in the brake controller, remaining functions may be removed/disabled except for the LKA and LFA of the function application.

As described above, there is an ADAS to self-restrict the internal function of the ADAS when another controller is hacked, to address the problem of the absence of an action for the ADAS function, when the hacking is sensed in the another controller (e.g., as there may be only a relief function for the internal function). Accordingly, the activation of the ADAS function may be prevented based on data, which is not reliable, from the other controller, and the safety of a driver may be warranted in a level-4-autonomous driving vehicle.

There is a method in which a system of the level-4-autonomous driving vehicle takes self-countermeasures when the hacking occurs. In particular, the apparatus for controlling the vehicle suggests countermeasures depending on controllers (longitudinal control, lateral control, ADAS, or vehicle network controller) related to an autonomous driving level.

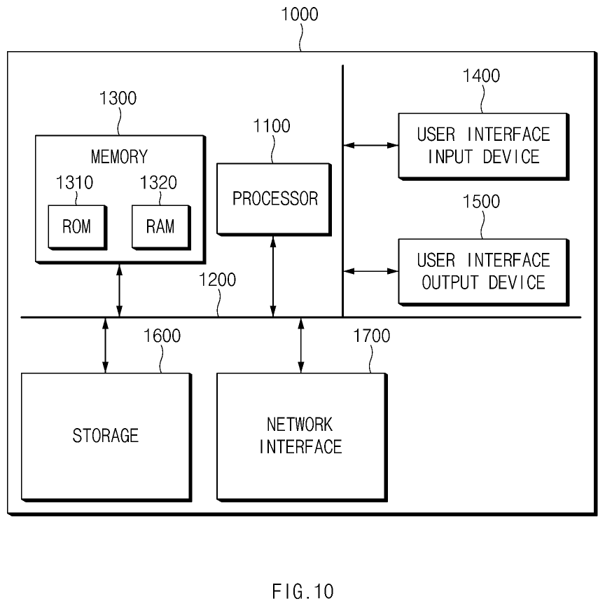

According to the present disclosure, the apparatus and the method may be implemented in the form of a program instruction executed through various computer units. The apparatus and the method may be recorded in a computer-readable medium, and may include a program instruction, a data file, or a data structure. The apparatus and the method may be implemented in hardware to execute the operation and the algorithm of the present disclosure, and illustrated in FIG. 10.

FIG. 10 illustrates a computing system.

Referring to FIG. 10, a computing system 1000 may include at least one processor 1100, a memory 1300, a user interface input device 1400, a user interface output device 1500, a storage 1600, and a network interface 1700, which may be connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile and/or non-volatile storage media. For example, the memory 1300 may include a read only memory (ROM) and a random access memory (RAM).

Thus, the operations of the methods and/or algorithms described herein may be directly implemented with a hardware module, a software module, or the combinations thereof, executed by the processor 1100. The software module may reside on a storage medium (e.g., the memory 1300 and/or the storage 1600), such as a RAM, a flash memory, a ROM, an erasable and programmable ROM (EPROM), an electrically EPROM (EEPROM), a register, a hard disc, a removable disc, and/or a compact disc-ROM (CD-ROM).

The exemplary storage medium may be coupled to the processor 1100. The processor 1100 may read out information from the storage medium and may write information in the storage medium. Alternatively or additionally, the storage medium may be integrated with the processor 1100. The processor and storage medium may reside in an application specific integrated circuit (ASIC). The ASIC may reside in a user terminal. Alternatively or additionally, the processor and storage medium may reside as separate components of the user terminal.

According to an aspect of the present disclosure, an apparatus for controlling a vehicle, may include a plurality of vehicle controllers configured to control the vehicle, an advanced driver assistance system (ADAS) configured to perform an ADAS function, a hacking monitoring system configured to monitor whether hacking is sensed in the vehicle, and a vehicle control device configured to adjust performance of the vehicle controller, when the hacking is sensed in the vehicle. The ADAS system may control an ADAS function related to the vehicle controller adjusted in performance, when the hacking is sensed.

According to an embodiment, the ADAS system may include a sensor fusion to receive and transmit an external sensing signal, a plurality of function applications to perform the ADAS function, and an ADAS control device to control the ADAS function.

According to an embodiment, the function application may include Forward Collision-Avoidance Assist (FCA), which is to assist forward collision-avoidance, Lane Keeping Assist (LKA), which is to assist lane keeping, Blind-Spot Collision-Avoidance Assist (BCA), which is to assist rearward collision-avoidance, Intelligent Speed Limit Assist (ISLA), which is to assist intelligent speed limit, Smart Cruise Control (SCC), which is to perform smart cruise control, Navigation-based Smart Cruise Control (NSCC), which is to perform navigation-based smart cruise control, Lane Following Assist (LFA), which is to assist lane following, Highway Driving Assist (HDA) and Highway Driving Assist 2 (HDA 2) which are to assist highway driving, or combination of the above functions.

According to an embodiment, the vehicle controller may include a power train controller to control longitudinally accelerating, and the ADAS control device may stop at least one function of the SCC, the NSCC, the HDA, the HDA 2, or the combination of the above functions, when the hacking is sensed in the power train controller.

According to an embodiment, the vehicle controller may include a brake controller to control longitudinally decelerating, and the ADAS control device may stop at least one function of the FCA, the BCA, the ISLA, the SCC, the NSCC, the HDA, the HDA 2, or the combination of the above functions, when the hacking is sensed in the brake controller.

According to an embodiment, the vehicle controller may include a steering controller to control lateral driving, and the ADAS control device may stop at least one function of the FCA, the LKA, the BCA, the LFA, the HDA 2 or the combination of the above functions, when the hacking is sensed in the steering controller.

According to an embodiment, the vehicle controller may include a gateway for vehicle networking, and the ADAS control device may stop all functions of the plurality of function applications, when the hacking is sensed the gateway.

According to an embodiment, the vehicle controller may include a vehicle to everything (V2X) controller for communication with an outside, and the ADAS control device may maintain the functions the of plurality of function applications, when the hacking is sensed in the V2X controller.

According to an embodiment, the vehicle controller may include an audio, video, and navigation (AVN) controller to control a user interface, the ADAS control device may stop the NSCC function, when the hacking is sensed in the AVN controller.

According to another aspect of the present disclosure, a method for controlling a vehicle including a vehicle controller to perform a function of the vehicle and an advanced driver assistance system (ADAS) system to perform an ADAS function, may include verifying whether hacking occurs in the vehicle, in real time, adjusting performance of the vehicle controller, when the hacking is sensed, and controlling the ADAS function related to the vehicle controller adjusted in performance.

The present disclosure provides an apparatus for controlling a vehicle and a method for the same, capable of controlling operations of relevant controllers, when a controller is hacked in an autonomous driving vehicle.

The present disclosure n apparatus for controlling a vehicle and a method for the same, enabling a system to perform a fallback function (e.g., in level 4 of autonomous driving).

The present disclosure provides an apparatus for controlling a vehicle and a method for the same, capable of controlling an ADAS controller, which is in charge of autonomous driving, for each function, when the vehicle is hacked.

Accordingly, the vehicle (e.g., a vehicle drivable in level 4 of autonomous driving) may safely drive through the main controller redundancy system.

A variety of effects directly or indirectly that may be understood through the disclosure may be provided.

The above description is merely an example of the technical idea of the present disclosure, and various modifications and modifications may be made by one skilled in the art without departing from the essential characteristic of the invention.

Hereinabove, although the present disclosure has been described with reference to various examples and the accompanying drawings, aspects of the present disclosure are not limited thereto, but may be variously modified and altered by those skilled in the art to which the present disclosure pertains without departing from the spirit and scope of the present disclosure claimed in the following claims.

What is claimed is:

1. An apparatus comprising:
a plurality of vehicle controllers configured to control a vehicle;
an advanced driver assistance system (ADAS) configured to perform at least one ADAS operation;
a hacking monitoring system configured to determine whether a hacking activity associated with the vehicle is detected; and
a vehicle control device configured to adjust, based on a detected hacking activity associated with the vehicle, performance of at least one vehicle controller of the plurality of vehicle controllers,
wherein the ADAS is configured to control, based on the detected hacking activity associated with the vehicle, an ADAS operation associated with the at least one vehicle controller.

2. The apparatus of claim 1, wherein the ADAS comprises:
a sensor fusion configured to receive an external sensing signal;
a plurality of function applications to perform the at least one ADAS operation; and
an ADAS control device to control the at least one ADAS operation.

3. The apparatus of claim 2, wherein the plurality of function applications comprises at least one of:
Forward Collision-Avoidance Assist (FCA) to assist forward collision-avoidance, Lane Keeping Assist (LKA) to assist lane keeping, Blind-Spot Collision-Avoidance Assist (BCA) to assist rearward collision-avoidance, Intelligent Speed Limit Assist (ISLA) to assist intelligent speed limit, Smart Cruise Control (SCC) to perform smart cruise control, Navigation-based Smart Cruise Control (NSCC) to perform navigation-based smart cruise control, Lane Following Assist (LFA) to assist lane following, or Highway Driving Assist (HDA) to assist highway driving,
wherein the at least one vehicle controller comprises a power train controller to control longitudinally accelerating, and
wherein the ADAS control device is configured to stop, based on a detected hacking activity associated with the power train controller, at least one function of: the SCC, the NSCC, or the HDA.

4. The apparatus of claim 2, wherein the at least one vehicle controller comprises:
a brake controller to control longitudinally decelerating, and
wherein the ADAS control device is configured to stop, based on a detected hacking activity associated with the brake controller, at least one function of: Forward Collision-Avoidance Assist (FCA), Blind-Spot Collision-Avoidance Assist (BCA), Intelligent Speed Limit Assist (ISLA), Smart Cruise Control (SCC), Navigation-based Smart Cruise Control (NSCC), or Highway Driving Assist (HDA).

5. The apparatus of claim 2, wherein the at least one vehicle controller comprises:
a steering controller to control lateral driving, and
wherein the ADAS control device is configured to stop, based on a detected hacking activity associated with the steering controller, at least one function of: Forward Collision-Avoidance Assist (FCA), Lane Keeping Assist (LKA), Blind-Spot Collision-Avoidance Assist (BCA), Lane Following Assist (LFA), Highway Driving Assist (HDA).

6. The apparatus of claim 2, wherein the at least one vehicle controller comprises:
a gateway for vehicle networking, and
wherein the ADAS control device is configured to stop, based on a detected hacking activity associated with the gateway, a plurality of functions of the plurality of function applications.

7. The apparatus of claim 2, wherein the at least one vehicle controller comprises:
a vehicle to everything (V2X) controller for communication with an external device, and
wherein the ADAS control device is configured to maintain, based on a detected hacking activity associated with the V2X controller, operating states of functions of the plurality of function applications.

8. The apparatus of claim 2, wherein the at least one vehicle controller comprises:
an audio, video, and navigation (AVN) controller to control a user interface, and
wherein the ADAS control device is configured to stop, based on a detected hacking activity associated with the AVN controller, at least one function of Navigation-based Smart Cruise Control (NSCC).

9. A method comprising:
determining, by a computing device, whether a hacking activity associated with a vehicle occurs;
adjusting, based on a detected hacking activity associated with the vehicle, performance of at least one vehicle controller of the vehicle; and
controlling at least one advanced driver assistance system (ADAS) operation associated with the at least one vehicle controller of which performance is adjusted.

10. The method of claim 9, wherein an ADAS of the vehicle comprises:
a plurality of function applications to perform the at least one ADAS operation, and
wherein the plurality of function applications comprises at least one of:
Forward Collision-Avoidance Assist (FCA) to assist forward collision-avoidance, Lane Keeping Assist (LKA) to assist lane keeping, Blind-Spot Collision-Avoidance Assist (BCA) to assist rearward collision-avoidance, Intelligent Speed Limit Assist (ISLA) to assist intelligent speed limit, Smart Cruise Control (SCC) to perform smart cruise control, Navigation-based Smart Cruise Control (NSCC) to perform navigation-based smart cruise control, Lane Following Assist (LFA) to assist lane following, or Highway Driving Assist (HDA) to assist highway driving.

11. The method of claim 10, wherein the at least one vehicle controller comprises:
a power train controller to control longitudinally accelerating, and
wherein the controlling of the at least one ADAS operation comprises:
stopping, based on a detected hacking activity associated with the power train controller, at least one function of: the SCC, the NSCC, or the HDA.

12. The method of claim 10, wherein the at least one vehicle controller comprises:
a brake controller to control longitudinally decelerating, and
wherein the controlling of the at least one ADAS operation comprises:
stopping, based on a detected hacking activity associated with the brake controller, at least one function of: the FCA, the BCA, the ISLA, the SCC, the NSCC, or the HDA.

13. The method of claim 10, wherein the at least one vehicle controller comprises:
a steering controller to control lateral driving, and
wherein the controlling of the at least one ADAS operation comprises:
stopping, based on a detected hacking activity associated with the steering controller, at least one function of: the FCA, the LKA, the BCA, the LFA, or the HDA.

14. The method of claim 10, wherein the at least one vehicle controller comprises:
a gateway for vehicle networking, and
wherein the controlling of the at least one ADAS operation comprises:
stopping, based on a detected hacking activity associated with the gateway, a plurality of functions of the plurality of function applications.

15. The method of claim 10, wherein the at least one vehicle controller comprises:
a vehicle to everything (V2X) controller for communication with an external device, and
wherein the controlling of the at least one ADAS operation comprises:
maintaining, based on a detected hacking activity associated with the V2X controller, operating states of functions of the plurality of function applications.

16. The method of claim 10, wherein the at least one vehicle controller comprises:
an audio, video, and navigation (AVN) controller to control a user interface, and
wherein the controlling of the at least one ADAS operation comprises:
stopping, based on a detected hacking activity associated with the AVN controller, at least one function of the NSCC.
